(19) United States
(12) Patent Application Publication
(10) Pub. No.: US 2023/0259991 A1
(43) Pub. Date: Aug. 17, 2023

(54) MACHINE LEARNING TEXT INTERPRETATION MODEL TO DETERMINE CUSTOMER SCENARIOS

(71) Applicant: Microsoft Technology Licensing, LLC, Redmond, WA (US)

(72) Inventors: Prabhakaran SETHURAMAN, Redmond, WA (US); Srishty SAHA, Redmond, WA (US)

(21) Appl. No.: 17/580,902

(22) Filed: Jan. 21, 2022

(51) Int. Cl. G06Q 30/02; G06N 7/00; G06F 40/279; G06F 40/30; G06F 40/166

(52) U.S. Cl. CPC G06Q 30/0282; G06F 40/30; G06F 40/166; G06F 40/279; G06N 7/005

(57) ABSTRACT

Methods, systems and computer program products are provided for a machine learning text interpretation model configured to determine customer scenarios, which may be unsupervised. Text (e.g., customer comments) may be processed by a text interpretation model to identify topics. Text features may be processed together or separately (e.g., in parallel flows) to identify one or more sets of topic categories. Text features (e.g., customer pain point comments and customer blocker comments) may be preprocessed, summarized, vectorized, topic modeled, clustered, and analyzed to select topic categories. A topic modeler may be selected from multiple topic modelers based on perplexity scores. The selected topic categories after clustering may be considered top customer scenarios, which are identified after operation of the machine learning (e.g., unsupervised) text interpretation model.

### BACKGROUND

In an effort to improve customer satisfaction, customer support agents provide support for customers of complex products, such as computer-implemented products (e.g., the Microsoft Azure® cloud platform with over two hundred products and cloud services and millions of customers). Such agents may assist customers with transitions between products and product versions. The customers and other partners may indicate reasons for utilizing one product or product version over another, such as reasons that prevent transition and/or requested features to transition.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for a machine learning text interpretation model. Text (e.g., customer comments) may be processed by a text interpretation model to identify topics. Text features may be processed together or separately to identify one or more sets of topic categories. Text features (e.g., customer pain point comments and customer blocker comments) may be optionally preprocessed, summarized, vectorized, topic modeled, clustered, and analyzed to select topic categories. A topic modeler may be selected from multiple topic modelers based on perplexity scores.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example computing environment for a machine learning text interpretation model, according to an embodiment.

FIG. 2 shows a block diagram of a categorization system that implements an unsupervised learning text interpretation model to generate categories based on features, according to an example embodiment.

FIG. 3 shows an example plot of a perplexity curve for the number of topics generated by the LDA topic model for a vectorized blocker feature dataset, according to an embodiment.

FIG. 4 shows an example plot of an analysis of blocker topic model clustering, according to an embodiment.

FIG. 5 shows an example plot of a perplexity curve for the number of topics generated by the LDA topic model for a vectorized pain point feature dataset, according to an embodiment.

FIG. 6 shows an example plot of an analysis of pain point topic model clustering, according to an embodiment.

FIG. 7 shows a flowchart of an example method for text interpretation based on an intent classifier model, according to an embodiment.

FIG. 8 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

In an effort to improve customer satisfaction, customer support agents provide support for customers of complex products, such as computer-implemented products (e.g., the Microsoft Azure® cloud platform with over two hundred products and cloud services and millions of customers). Such agents may assist customers with transitions between products and product versions. The customers and other partners may indicate (e.g., in comments) reasons for utilizing one product or product version over another, such as reasons that prevent transition and/or requested features to transition. Customer and/or partner comments may be voluminous, which may be extremely time-consuming for engineering teams to review, interpret, correlate with comments by others, determine, and schedule product improvements. Embodiments described herein enable such comments to be categorized in an efficient manner such that they can readily acted upon.

In particular, methods, systems and computer program products are provided for a machine learning text interpretation model. Text (e.g., customer comments) may be processed by an (e.g., unsupervised) learning-based text interpretation model configured to determine customer scenarios, including being configured to identify the impact of a scenario with respect to one or more topics (e.g., product improvement categories). Text features may be processed together or separately (e.g., in parallel flows) to identify one or more sets of topic categories. Text features (e.g., customer pain point comments and customer blocker comments) may be preprocessed (e.g., normalized), summarized (e.g., selectively for length), vectorized, topic modeled, clustered (e.g., by K-means clustering) and analyzed (e.g., based on silhouette scores) to select topic categories. A topic modeler may be selected from multiple topic modelers based on perplexity scores.

Note that as used herein, a “blocker comment” refers to a reporting of a functional issue in the computer-implemented product(s) of a user that blocks the user (e.g., a customer) from being able to complete an operation (a blocking issue), and hence, the user desires reasonably prompt remediation. Furthermore, a “pain point comment” refers to a reporting of a feature request and/or a functional issue (a pain point issue) in the computer-implemented product(s) of a user for modification (implementation and/or correction) to improve the product experience of the user, and hence, may not need as rapid handling relative to a blocking issue reported in a blocker comment. Supportability work items or bug-fixes for user reported pain-points may be delivered according to severity of the issue, for instance.

The present subject matter is discussed in the context of one or more of many possible examples. In some examples, a computer-implemented commerce platform may provide various opportunities for partners, consumers, enterprise customers, etc. to utilize one or more versions of available products and services. Partners, consumers, enterprise customers, etc. (referred to generally as customers) may indicate (e.g., in comments to customer experience agents) their needs, preferences, and/or indications whether they plan to migrate to newer versions of products and/or services (e.g., platforms). Customer experience agents may generate significant amounts of information for customers. In some examples, the information may be tracked as customer care cases in a commerce support tool (CST). Case information may reflect a customer’s views regarding and/or a status of product (e.g., platform) migration. Case information may indicate the current platform for a customer (e.g., legacy or modem), answers to customer experience questions, blocker comments indicating issues for modem migration, desired product features, pain-points, etc. Case information may be voluminous for each of many customers (e.g., hundreds to thousands of new cases per week). Manual analysis and aggregation of potential product issues indicated by the intent expressed in blocker comments, desired features, and pain-points may divert significant resources from product engineering and delay implementation.

A product and/or service provider may invest significant resources to understand and prioritize customer needs and preferences to improve product satisfaction. Improved customer experience may lead to an increase in customer satisfaction scores. Input from customers and/or support agents may be immense for a widely used complex product, such as a software platform product. A text interpretation model (e.g., with unsupervised learning) may quickly determine and prioritize issues for work items across many inputs from many agents to improve customer satisfaction with products.

Automation of review and interpretation of comments may reduce the delay between comments and improvements. An (e.g., unsupervised) intent (e.g., described issue) classification model may automatically identify issues (e.g., topics, subjects, intents, objectives, purposes) and/or issue priorities expressed by partners, consumers, enterprise customers, etc. An intent classification model may be unsupervised, for example, if there is no ground truth of issue areas for a large dataset to train the model. An (e.g., unsupervised) intent classification model may be implemented by machine learning (ML) and natural language processing (NLP) techniques based on features extracted from raw input (e.g., comments), such as customer pain-points, desired features, their reasoning for migration to a platform. Fast, automated determination of issues (e.g., intents) may allow product/service engineering teams to improve responsiveness (e.g., reduce the time to market) by more quickly identifying issues (e.g., problems), mitigations (e.g., solutions) and implementation priorities. For example, a customer may indicate that they would transition to a newer platform if one or more issues are resolved. An (e.g., unsupervised) intent classification model may provide a proactive approach to improve product/service experience for others.

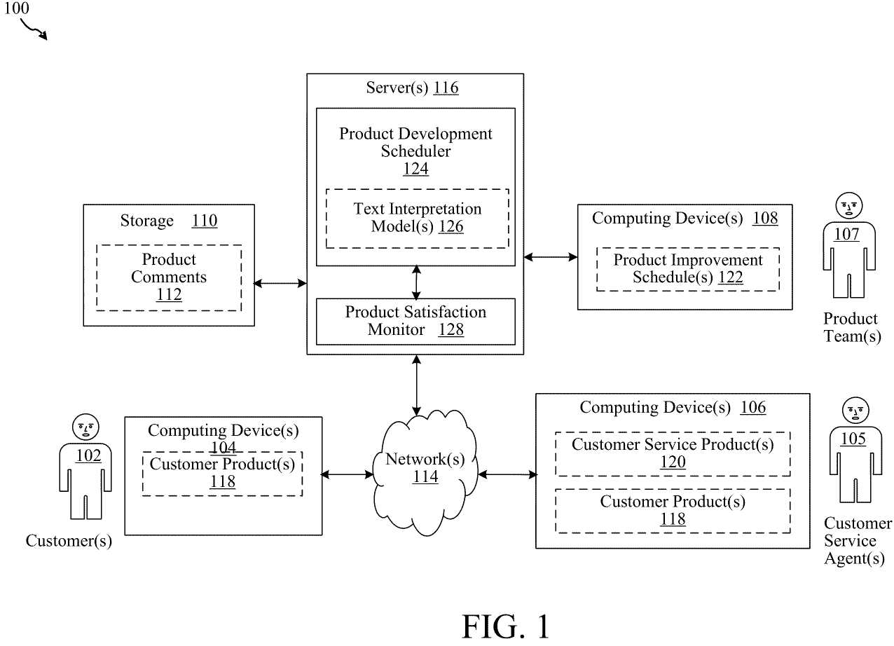

FIG. 1 shows a block diagram of an example computing environment 100 for one or more machine learning text interpretation models 126, according to an example embodiment. A text interpretation model of model(s) 126 is configured to categorize received comments in an efficient manner such that they can readily acted upon. Herein, text interpretation model(s) 126 is/are shown in the context of automated interpretation of voluminous customer comments to provide input to a product development scheduler to schedule product improvements based on the customer comments. Such implementations of text interpretation models may be applied to other applications as well.

As shown in FIG. 1, computing environment 100 may include, for example, one or more computing devices 104, which may be used by one or more product customers 102, one or more computing devices 106, which may be used by one or more customer service agents 105, one or more computing devices 108, which may be used by one or more product teams 107, one or more networks 114, one or more servers 116, and storage 110. Example computing environment 100 presents one of many possible examples of computing environments. Example computing environment 100 may comprise any number of computing devices and/or servers, such as the example components illustrated in FIG. 1 and other additional or alternative devices not expressly illustrated.

Network(s) 114 may include, for example, one or more of any of a local area network (LAN), a wide area network (WAN), a personal area network (PAN), a combination of communication networks, such as the Internet, and/or a virtual network. In example implementations, computing device(s) 104 and server(s) 116 may be communicatively coupled via network(s) 114. In an implementation, any one or more of server(s) 116 and computing device(s) 104 may communicate via one or more application programming interfaces (APIs), and/or according to other interfaces and/or techniques. Server(s) 116 and/or computing device(s) 104 may include one or more network interfaces that enable communications between devices. Examples of such a network interface, wired or wireless, may include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein.

Computing device(s) 104 may comprise computing devices utilized by one or more customers (e.g., individual users, family users, enterprise users, governmental users, administrators, etc.) generally referenced as customer(s) 102. Computing device(s) 104 may comprise one or more applications, operating systems, virtual machines (VMs), storage devices, etc. that may be executed, hosted, and/or stored therein or via one or more other computing devices via network(s) 114. In an example, computing device(s) 104 may access one or more server devices, such as server(s) 116, to request service (e.g., service request (SR)) and/or to provide information, such as product comments 112. Computing device(s) 104 may represent any number of computing devices and any number and type of groups (e.g., various users among multiple cloud service tenants). Customer(s) 102 may represent any number of persons authorized to access one or more computing resources. Computing device(s) 104 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 104 are not limited to physical machines, but may include other types of machines or nodes, such as a virtual machine.

In some examples, customer product(s) 118 may be one or more computer products (e.g., hardware, firmware or software) in computing device(s) 104 used by customer(s) 102. Customer(s) 102 may use customer product(s) 118 in computing device(s) 104. Customer(s) 102 may provide product comments 112 to product satisfaction monitor 128 (e.g., via an online submission form) and/or through communication with customer service agent(s) 105 (e.g., based on an SR and/or by agent contact).

Computing device(s) 106 may comprise computing devices utilized by one or more customer service agent(s) 105. Computing device(s) 106 may comprise one or more applications, operating systems, virtual machines (VMs), storage devices, etc. that may be executed, hosted, and/or stored therein or via one or more other computing devices via network(s) 114. In an example, computing device(s) 106 may access one or more server devices, such as server(s) 116, to provide (e.g., on behalf of customer(s) 102) and/or access information, such as SRs, case reports, product comments 112, etc. Computing device(s) 106 may represent any number of computing devices and any number and type of groups (e.g., various users among multiple cloud service tenants). Customer service agent(s) 105 may represent any number of persons authorized to access one or more computing resources. Computing device(s) 106 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 106 are not limited to physical machines, but may include other types of machines or nodes, such as a virtual machine.

Customer service agent(s) 105 may field service requests (SRs) from customer(s) 102 and/or may contact customer(s) 102 regarding customer product(s) 118 or related matters, such as billing. Agent-customer interactions may result in generation of product comments 112 in one form or another. Customer comments 112 may reference customer product(s) 118. For example, customer service agent(s) 105 may receive product satisfaction (SAT) reports from customer(s) 102 for customer product(s) 118. Customer service agent(s) 105 may create SRs for customer(s) 102. Customer service agent(s) 105 may create SR (e.g., case) tickets for SRs and/or based on agent contact with customers, such as to inquire about transition to one or more products or versions thereof. Customer service agent(s) 105 may use customer service products 120 to provide service to customer(s) 102. Customer service product(s) 120 may include, for example, a commerce support tool (CST). Customer service product(s) 120 may be used to generate product comments 112, e.g., as part of a case ticket. Customer service agent(s) 105 may generate product SAT (satisfaction) reports, transition status reports, etc. regarding customer experience with customer product 118. Customer service agent(s) 105 may interact with product satisfaction monitor 128 to provide and/or to retrieve information, such as customer SAT reports, case tickets, product comments 112, etc. For example, customer service agent(s) 105 may provide agent SAT reports to product satisfaction monitor 128 (e.g., via an online submission form).

Computing device(s) 108 may comprise computing devices utilized by one or more product engineering team(s) 107. Computing device(s) 108 may comprise one or more applications, operating systems, virtual machines (VMs), storage devices, etc. that may be executed, hosted, and/or stored therein or via one or more other computing devices (e.g., server(s) 116). In an example, computing device(s) 108 may access one or more server devices, such as server(s) 116, to provide and/or access information, such as product comments 112, product improvement schedule(s) 122 based (e.g., at least in part) on product comment(s) 112, etc. Computing device(s) 108 may represent any number of computing devices and any number and type of groups (e.g., various users among multiple cloud service tenants). Product team(s) 107 may represent any number of persons authorized to access one or more computing resources. Computing device(s) 108 may each be may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Computing device(s) 108 are not limited to physical machines, but may include other types of machines or nodes, such as a virtual machine.

Product team(s) 107 may represent one or more product teams (e.g., customer product teams and/or customer service product (service tool) teams). Product team(s) 107 may improve products (e.g., to create improved products) based on product improvement schedule(s) 122 provided by product development scheduler 124. Product improvement schedule(s) 122 may include schedules for one or more products (e.g., customer products and/or customer service products, which may be referred to as service tools). Product team(s) 107 may develop improvements to customer product(s) 118 and/or customer service product(s) 120 by creating solutions to issues reported in product comments 112, which may be addressed by product team(s) 107 in a prioritized order by product improvement schedule(s) 122.

Server(s) 116 may comprise one or more computing devices, servers, services, local processes, remote machines, web services, etc. to monitor product satisfaction, store product comments 112, interpret product comments 112, and prioritize product development based on classification of product issues by text interpretation model(s) 126, etc. In an example, server(s) 116 may comprise a server located on an organization’s premises and/or coupled to an organization’s local network, a remotely located server, a cloud-based server (e.g., one or more servers in a distributed manner), or any other device or service that may host, manage, and/or provide text interpretation model(s) 126, model evaluation and selection, etc. Server(s) 116 may be implemented as a plurality of programs executed by one or more computing devices. Server programs and content may be distinguished by logic or functionality (e.g., as shown by example in FIG. 1).

Server(s) 116 may include product satisfaction monitor 128. Product satisfaction monitor 128 may (e.g., passively and/or actively) receive and/or request information pertaining to product satisfaction of customers 102 with customer products 118. For example, product satisfaction monitor 128 may provide an online (e.g., Web) form for customers 102 and/or agents 105 to fill out. Product satisfaction monitor 128 may receive, organize and store information received from customers 102 and/or agents 105, for example, as product comments 112 in storage 110. Product comments 112 may include, for example, blocker comments and/or pain point comments related to transition between products or versions thereof. Product satisfaction monitor 128 may provide (e.g., online, by email) product surveys for customers 102 and/or agents 105 to fill out to describe satisfaction/dissatisfaction and/or any issues with one or more products. Product satisfaction monitor 128 and storage 110 may provide as an organized repository (e.g., structured query language (SQL) database) of product satisfaction information.

Product satisfaction monitor 128 is configured to store and/or retrieve product comments 112 in storage 110. Customers may unilaterally report and/or may respond to surveys (e.g., from product satisfaction monitor 128) about their experiences and/or requests for product features, which may be stored as product comments 112 in storage 110. Customer service product(s) 120 may include a commerce support tool (CST), which may store and/or retrieve product comments 112 in storage 110. Customer service product(s) 120 may interface with product satisfaction monitor(s) 128.

Server(s) 116 include product development scheduler 124. Product development scheduler 124 is configured to generate product improvement schedule(s) 122 for product team(s) 107. Product development scheduler 124 includes text interpretation model(s) 126. Text interpretation model(s) 126 are configured to improve customer satisfaction by prioritizing improvements in customer product(s) 118 (e.g., products the customer uses and/or may transition into using) based on classification of interpretations of product comments 112. Text interpretation model(s) 126 may include one or more of, for example, a feature extractor, a feature preprocessor, a summarizer, a vectorizer, a topic modeler, a clusterer and a topic categorizer, depending on the particular implementation.

For instance, when present, a feature extractor is configured to extract features from product comments 112. Features may include, for example, customer status, pain points, blocker comments, etc. A feature preprocessor may use NLP techniques to “normalize” extracted features, for example, by converting text to lowercase, removing stop words, tokenization, stemming, lemmatization, etc. A summarizer may (e.g., selectively) reduce the length of one or more features by summarizing text (e.g., if the text exceeds a threshold length). A vectorizer may represent (e.g., encode) words as vectors. A topic modeler may generate a set of topic models based on vectorized keywords. A clusterer may perform clustering of the topic models based on probabilities of keywords in the topic models. Clustering may assist with removing correlation between topic models, which may alter (e.g., reduce the number of) the topic models. A topic categorizer may analyze the clustering to determine a set of topic categories.

Text interpretation model(s) 126 may improve the performance (e.g., accuracy) of computerized text interpretation useful for many different purposes. In the example provided, automated review of product comments 112 may also accelerate product improvements, for example, by permitting manpower to be shifted from review to implementation of product improvements.

Product development scheduler 124 is configured to generate product improvement schedule(s) 122, indicating to product team(s) 107 priorities for remediation (e.g., in an improved product). Product development scheduler 124 is configured to use the set of topic categories derived from automated review of the product comments 112 to generate a schedule and priorities for product improvements, as may be indicated in product improvement schedule(s) 122. Product improvement schedule(s) 122 may associate a product improvement with a product category associated with one or more product comments 112. In an example, priorities may be based, at least in part, on customer status 212, the number of comments with similar topic categories, etc. For example, a product or service provider may prioritize remedies based on a determination that twenty customers indicate in product comments 112 or extracted features (e.g., customer status, pain points and/or blocker comments) that they would upgrade to a newer platform based on similar topic categories.

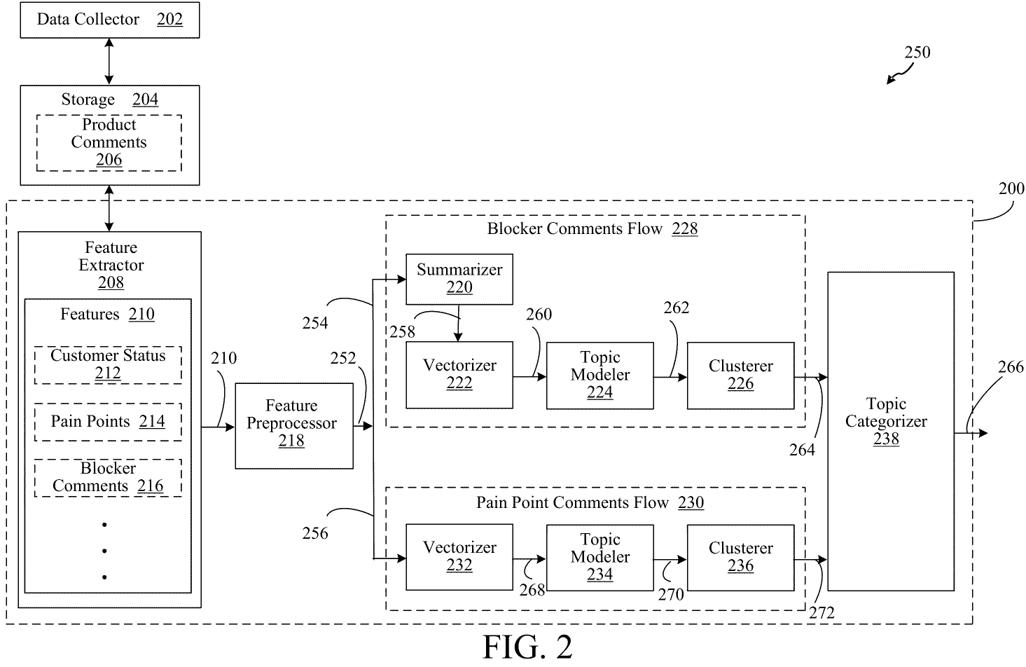

FIG. 2 shows a block diagram of a categorization system 250 that implements an unsupervised learning text interpretation model 200 to generate categories based on features, according to an example embodiment. For example, categorization system 250 may be implemented in product development scheduler 124 of FIG. 1. As shown in FIG. 2, categorization system 250 includes a data collector 202, storage 204, and text interpretation model 200. Example model 200 is one of many example implementations of a text interpretation model, including text interpretation model 126 of FIG. 1. As shown in FIG. 2, model 200 may include, for example, a feature extractor 208, a feature preprocessor 218, a summarizer 220, first and second vectorizers 222 and 232, first and second topic modelers 224 and 234, first and second clusterers 226 and 236, and a topic categorizer 238. Model 200 may operate on data collected by data collector 202, which may be stored as product comments 206 in storage 204.

Data collector 202 is configured to perform data collection. Data collected may be stored as product comments 206 in storage 204. In the customer service-related example of text interpretation model 200 shown in FIG. 2, product satisfaction monitor 128 in FIG. 1 may be an example of data collector 202. Customer service product(s) 120 may be another example of data collector 202.

In some examples, a customer experience team may contact customers and/or potential customers who may be interested in migrating to one or more products (e.g., from existing products they use). Customer service agents (e.g., in a customer experience team) may use a CST to create cases to track information for each customer or potential customer, which may be stored as product comments 206 in storage 204. For example, agents may track information about product experiences, requested features, interest in transitioning to one or more products (e.g., to make a deal for modem migration). Information may include one or more types of information, such as customer pain-points, blocker comments, desired features, reasons for and/or against product migration, customer status, etc. For example, a customer status may indicate a deal or transaction status, such as “Closed -Won,” which may indicate an agreement to transition to one or more products. Customer information may include pain-points and blockers (e.g., product issues) in the customer’s existing product(s) (e.g., legacy platform) and/or transition product(s) (e.g., modem platform) the customer wants solved (e.g., and the product/service provider agreed to solve) in the transitioned product(s). A customer status may be “Closed-Lost,” which may indicate that a customer has not agreed to transition to and/or continue using one or more products. Customer information may include pain-points and blockers (e.g., product issues) in the customer’s existing product(s) (e.g., legacy platform) and/or transition product(s) (e.g., modem platform) the customer wants solved.

Feature extractor 208 is configured to fetch product comments 206, for example, from case information stored for each customer in storage 204. Storage 204 may be an SQL database (DB). Feature extractor 208 may extract features that contribute to understand the overall intent or perspective of customer issues or blockers. Feature extractor 208 may extract features based on unsupervised learning. Feature extractor 208 may extract features 210 (one or more input customer features) from product comments 206. Features 210 may include, for example, a customer status 212, one or more blocker comments 216 (e.g., first input features), one or more pain points features 214 (e.g., second input features), etc. Blocker comments 216 may indicate reasons why a customer is apprehensive about transitioning (e.g., upgrading) to a product (e.g., a newer version of a product).

As shown in FIG. 2, feature preprocessor 218 receives features 210 from feature extractor 208 and is configured to preprocess features 210 to generate preprocessed features 252. Feature preprocessor 218 may use NLP techniques to “normalize” the (e.g., raw) text in extracted features, for example, by converting text to lowercase, removing stop words, part of speech (POS) tagging, tokenization, stemming, lemmatization, etc., to generate preprocessed features 252. A dataset of stop words may be customized. For example, some stops words (e.g., “should”, “must” or “can”) may be retained rather than removed if they can semantically refer to deontic expressions, such as a “prohibition” or “permission.” Retaining some stop words may help prevent contextual information loss and/or may help resolve semantic disambiguation.

Text interpretation model 200 may have multiple text processing flows. Each flow may process one or more of preprocessed features 252 (or features 210, when preprocessing is not performed). In the example shown in FIG. 2, text interpretation model 200 includes two flows: blocker comments flow 228 and pain points comments flow 230 that each receive at least a portion of preprocessed features 252. Blocker comments flow 228 may process one or more preprocessed blocker comments features 254 (e.g., first preprocessed input features) of preprocessed features 252, which are preprocessed versions of blocker comments 216 generated by feature preprocessor 218. Pain points comments flow 230 may process one or more preprocessed pain points features 256 (e.g., second preprocessed input features) of preprocessed features 252, which are preprocessed versions of pain points 214 generated by feature preprocessor 218. Blocker comments flow 228 may include, for example, summarizer 220, vectorizer 222, topic modeler 224 and clusterer 226. Pain points comments flow 230 may include, for example, vectorizer 232, topic modeler 234 and clusterer 236.

Summarizer 220 may (e.g., selectively) reduce the length of one or more features of preprocessed blocker comments features 254 by summarizing text (e.g., if the text exceeds a threshold length) to generate summarized text 258. In the example shown in FIG. 2, some blocker comment features mentioned by customers for each case may have variable lengths ranging from one sentence to ten sentences. Summarizer 220 may implement, for example, a deep learning-based Tensorflow text summarization model. Summarizer 220 may be (e.g., selectively) applied to features (e.g., blocker comment features) having a length greater than three (3) sentences (e.g., or greater than a threshold number of words or characters). Summarizer 220 may retain (e.g., capture) vital information (e.g., while eliminating redundant information). Summarizer 220 (e.g., a model implemented by summarizer 220) may consider words and/or word phrases to create a summary, which may avoid or reduce data loss. Summarization results may be (e.g., selectively) validated (e.g., by a product engineering team) compared to original text.

In an example, an original or raw blocker comment feature may be five sentences: “Sellers are having difficulties finding the right SKUs (stock keeping units) to use. Sellers have a list of EA SKUs to discount and are struggling to find the right products. Search by meter helps but they do not always have the meter ID available. In this example a discount was needed for a new product. MACC commitment is always from ‘First of this months’ regardless of the day on which the MCA is actually signed- customer signing towards the end of the month lose up to a month of being able to consume against the commit.” Summarizer 220 may reduce the five-sentence blocker comment to a three-sentence summarized blocker comment: “Sellers are having difficulties finding the right SKUs to use. Search by meter helps but they do not always have the meter ID available. MACC commitment is always from ‘First of this months’ regardless of the day on which the MCA is actually signed.”

Vectorizer 222 may operate on extracted, processed and (e.g., selectively) summarized features (summarized text 258 generated by summarizer 220) of preprocessed blocker comments features 254 (first summarized and/or preprocessed input features) in blocker comments flow 228. Vectorizer 222 may implement a vectorization model, such as, for example, Gensim’s Word2vec model. Vectorizer 222 may represent (e.g., encode) words as vectors. Vectorizer 222 (e.g., the vectorizer model) may generate word embedding for blocker comments by applying a continuous bag of words based neural network architecture. The training process for vectorizer 222 (e.g., vectorizer model) may be an unsupervised learning process (e.g., using Gensim). A set of words of interest may be used to evaluate similarity on, every certain steps. The performance of the vectorizer model may be evaluated by looking the most related words of those query words. Vectorized text 260 generated by vectorizer 222 may be utilized by topic modeler 224 to perform topic modeling.

Topic modeler 224 may perform topic modeling on vectorized features (e.g., vectorized blocker comment feature) of vectorized text 260 (first vectorized preprocessed input features) generated by vectorizer 222 in blocker comments flow 228 to generate blocker comment topic models 262. Topic modeler 224 may generate a number of blocker topic models for a vectorized blocker comment feature. In some examples, topic models for a variable length dataset may range from five (5) topics models to 50 topic models. Information loss and/or redundancy may occur, for example, if a limitation on the number of topic models is imposed on a (e.g., feature) dataset (e.g., as a whole).

In some examples, multiple topic models may be applied to vectorized features, with an analysis to select the topic model with better performance than one or more other topic models. Topic models may include, for example, BERTopic and Gensim’s Latent Dirichlet Allocation (LDA) topic model. In some examples, BERTopic and LDA may be applied to vectorized blocker comment features. Performance of multiple topic models may be measured, for example, by generating and comparing perplexity scores on the results generated by each model. Perplexity is a statistical measure indicating how well a probability model predicts a sample. The lower the perplexity, the better the topic model. A perplexity score for a first model may be better (e.g., lower) than a perplexity score for a second model, indicating that the first model may be a better fit (e.g., the best fit) model (e.g., for the models applied to the vectorized features). Table 1 shows an example of the (e.g., approximate) mean perplexity score for BERTopic and LDA topic models applied to a vectorized blocker feature.

TABLE 1

| Feature | Bert | LDA |
|---|---|---|
| Blockers | -3.13 | -4.26 |

In an example, Gensim’s LDA topic model may result in a lower (e.g., overall) perplexity score (e.g., -4.26 is less than -3.13). Gensim’s LDA topic model may be selected over BERTopic based on a comparison of perplexity scores. Gensim’s LDA topic model may be applied to the vectorized blocker feature. A perplexity measure may be used to identify (e.g., the predicted best) “n” number of topics (e.g., to extract) for expressed intent (e.g., issue, topic) identification from the blocker comment feature set.

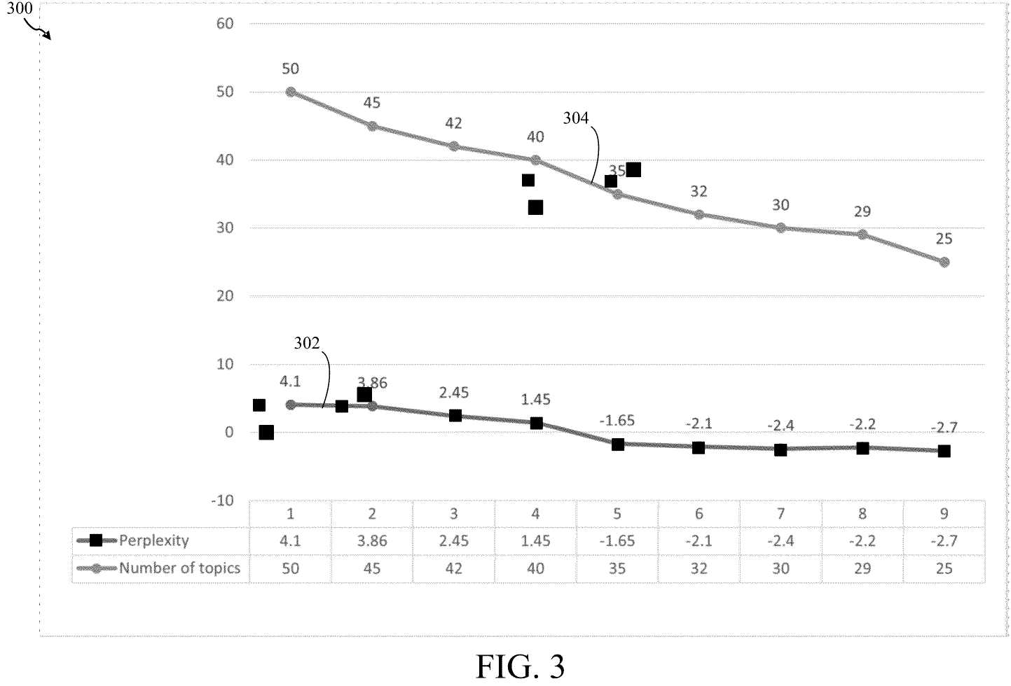

FIG. 3 shows an example plot 300 of a perplexity curve 302 for a number of topics generated by the LDA topic model for a vectorized blocker feature dataset, according to an example embodiment. In particular, plot 300 includes a plot line of the perplexity curve 302 and a plot line 304 of a corresponding number of topics. As shown by example blocker perplexity curve 300, the blocker perplexity score for the blocker feature is lowest for 30 topics [2.4 at 30 and -2.7 at 25 topics]. Table 2 shows keywords representing five (5) of 30 blocker topic models extracted from the vectorized blocker feature dataset using Gensim’s LDA topic model.

TABLE 2

| | |
|---|---|
| Topics | Keywords representing the topic model |
| Topic 1 | account, billing, customer, mca, quote, readiness, platform separate, terms, invoicing, vat, email, receive, invoice, portal |
| Topic 2 | payment, purchase, debited, debit, automate, allows, aws, mac, error, complete |
| Topic 3 | customer, gov, not, renewing |
| Topic 4 | quote, create, seller, MCA, sign, documentation |
| Topic 5 | macc, agreement, customer, mca, sce, aco, sign, available, renewal new |

As shown by example Table 2, topic model 1 is associated with keywords such as account, billing, platform, invoicing, etc., which may indicate one or more functional types of issues with billing and invoicing aspects of a (e.g., computer implemented) product. Keywords associated with topic model 2 may indicate one or more payment related issues with the (e.g., computer-implemented) product. Keywords associated with topic model 3 may indicate government customer issues. Keywords associated with topic model 4 and topic model 5 may indicate issues pertaining to agreement signatures. Broader intents of blocker comments mentioned by customers may be identified. Topic models 4 and 5 may be correlated with each other. High correlation within topic models may form a cluster of topic models that represent a broader perspective or intent of a customer’s needs and pain-points. Narrowing down the number of intents or topic models (e.g., to reduce correlated topic models) may improve training and performance for unsupervised learning-based intent identification.

Clusterer 226 receives and is configured to cluster blocker comment topic models 262 in blocker comments flow 228 to generate blocker comment topic model clusters 264. Clusterer 226 may fetch or receive multiple (e.g., 30) blocker topic models. There may be (e.g., high) correlation among the blocker topic models (e.g., within a topic category). Clustering may assist with removing correlation between blocker topic models, which may alter (e.g., reduce the number of) blocker topic models. Reducing (e.g., narrowing) the number of blocker topic models or intent categories may reduce or avoid redundancy and improve the text analysis to understand broader perspectives of customer needs. Clusterer 226 may implement, for example, K-means clustering on probabilities of keywords associated with each topic model. K means clustering on raw text may generate less accurate results due to the high dimensionality of raw text. Raw comment text may have high dimensionality and may include high correlation within different sections of text. Dimensionality may be reduced without significant information loss. Clustering based on probabilities of topic models, modeling based on summarized text, feature extraction and/or feature reduction may improve the accuracy of a text interpretation model. Clusterer 226 (e.g., K means clustering) may be trained on the blocker topic model feature set.

Topic categorizer 238 receives and is configured to analyze blocker topic model clusters 264 to determine a set of blocker comment topic categories that are included in output categories 266 generated by topic categorizer 238. Topic categorizer 238 may perform an analysis of blocker topic model clustering. Blocker topic model clustering may be evaluated, for example, using a silhouette analysis to determine best K intents or clusters. Topic categorizer 238 may (e.g., be configured to) determine a set of blocker topic categories based on the set of clusters of blocker topic models.

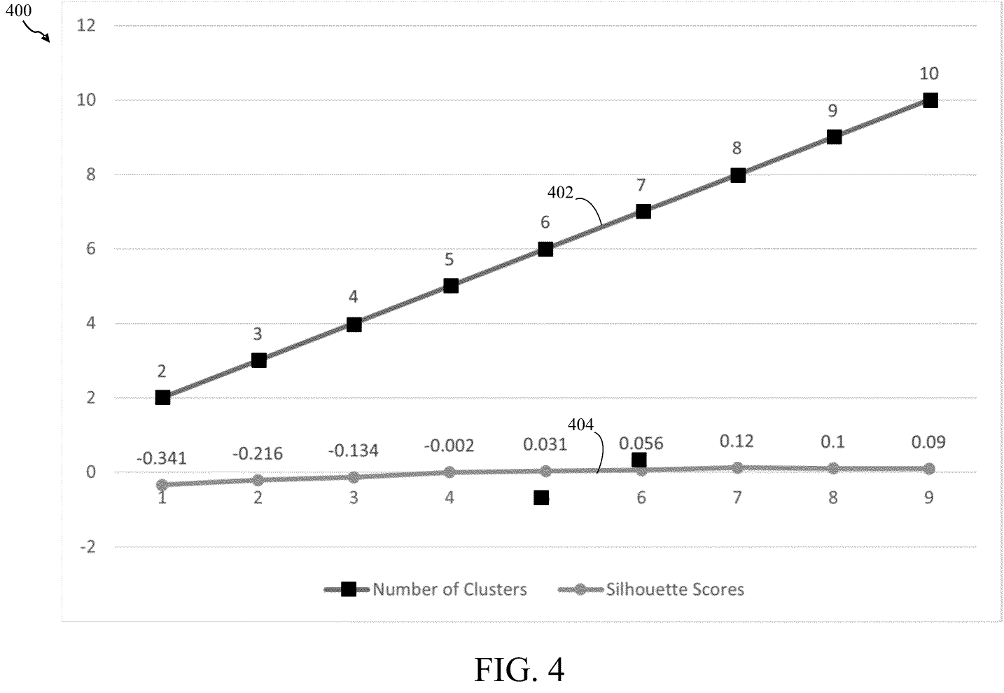

FIG. 4 shows an example plot 400 of an analysis of blocker comment topic model clustering, according to an example embodiment. In particular, plot 400 includes a plot line 402 of a number of clusters and a plot line 404 of corresponding silhouette scores. Example plot 400 shows that clusters of blocker topic models include overlapping blocker topic models, e.g., due to high correlation of blocker topic models generated by blocker topic modeler 224. As shown in FIG. 4, if blocker topic models form two clusters, the silhouette score is -0.341, which indicates that the clusters are overlapping completely with each other. The silhouette score improves as the number of clusters increases, which signifies that clusterer 226 (e.g., K-means clustering model) is learning new features from the blocker topic models, e.g., based on vectorizer 222 (e.g., Word2Vec word embedding model), resulting in an improvement in the spread (e.g., separation) of clusters of topic models. As shown in FIG. 4, the silhouette score reaches a maximum silhouette score (e.g., 0.12) at eight (8) clusters of blocker topic models. The silhouette score decreases with more than eight (8) clusters.

In one example, topic categorizer 238 may (e.g., based on the peak silhouette scores) determine, identify or select eight (8) blocker topic categories (e.g., eight (8) clusters of topic models) of clustered blocker comment topic modes 262 as an indication (e.g., the best indication) of intents expressed by customers in blocker comments within product comments 206.

With reference to pain point comments flow 230, vectorizer 232 receives and is configured to operate on extracted, processed and (e.g., selectively) summarized features of preprocessed pain points features 256 (second preprocessed input features). Vectorizer 232 may implement a vectorization model, such as, for example, Gensim’s Word2vec model. Vectorizer 232 may represent (e.g., encode) words as vectors. Vectorizer 232 (e.g., the vectorizer model) may generate word embedding for pain point comments by applying a continuous bag of words based neural network architecture. The training process for vectorizer 232 (e.g., vectorizer model) may be an unsupervised learning process (e.g., using Gensim). A set of words of interest may be used to evaluate similarity on, every certain steps. The performance of the vectorizer model may be evaluated by looking the most related words of those query words. Vectorized text 268 generated by vectorizer 232 based on preprocessed pain points features 256 may be utilized by topic modeler 234 to perform topic modeling.

Topic modeler 234 is configured to perform topic modeling on the included vectorized features (e.g., vectorized pain point comment feature) of vectorized text 268 (second vectorized preprocessed input features) to generate pain point topic models 270. Topic modeler 234 may generate a number of pain point topic models for a vectorized pain point comment feature. In some examples, topic models for a variable length dataset may range from five (5) topics models to 50 topic models. Information loss and/or redundancy may occur, for example, if a limitation on the number of topic models is imposed on a (e.g., feature) dataset (e.g., as a whole).

In some examples, multiple topic models may be applied to vectorized features, with an analysis to select the topic model with better performance than one or more other topic models. Topic models may include, for example, BERTopic and Gensim’s Latent Dirichlet Allocation (LDA) topic model. In some examples, BERTopic and LDA may be applied to vectorized pain point comment features. Performance of multiple topic models may be measured, for example, by generating and comparing perplexity scores on the results generated by each model. Perplexity is a statistical measure indicating how well a probability model predicts a sample. The lower the perplexity, the better the topic model. A perplexity score for a first model may be better (e.g., lower) than a perplexity score for a second model, indicating that the first model may be a better fit (e.g., the best fit) model (e.g., for the models applied to the vectorized features). Table 3 shows an example of the (e.g., approximate) mean perplexity score for BERTopic and LDA topic models applied to a vectorized pain point feature.

TABLE 3

| Feature | Bert | LDA |
|---|---|---|
| Pain points | -1.43 | -2.18 |

In an example, Gensim’s LDA topic model may result in a lower (e.g., overall) perplexity score (e.g., -2.18 is less than -1.43). Gensim’s LDA topic model may be selected over BERTopic based on a comparison of perplexity scores. Gensim’s LDA topic model may be applied to the vectorized pain point feature. A perplexity measure may be used to identify (e.g., the best) “n” number of topics (e.g., to extract) for expressed intent (e.g., issue, topic) identification from the pain point comment feature set.

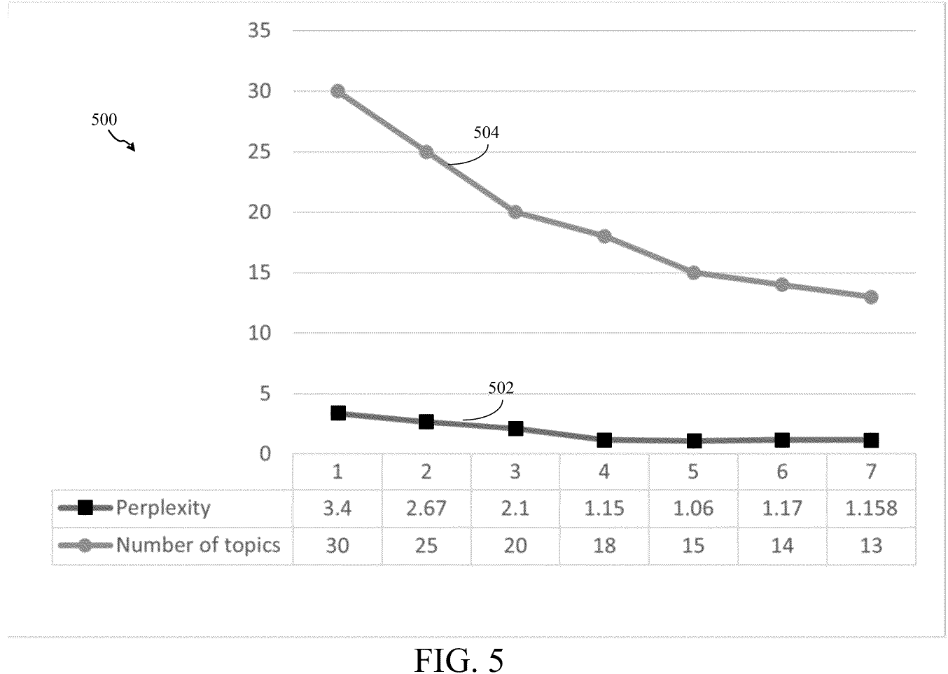

FIG. 5 shows an example plot 500 of a perplexity curve 502 for a number of topics 504 generated by the LDA topic model for a vectorized pain point feature dataset, according to an embodiment. As shown by example pain point perplexity curve 502, the pain point perplexity score (e.g., 1.06) for the pain point feature is lowest for 15 topics. Table 4 shows keywords representing five (5) of 10 pain point topic models extracted from the vectorized pain point feature dataset using Gensim’s LDA topic model.

TABLE 4

| | |
|---|---|
| Topics | Keywords representing the topic model |
| Topic 1 | billing, subs, account, mca, portal, fl, transferred, tool |
| Topic 2 | subs, invoice, migrate, payment, missing, plans, macc, failed, quote, split |
| Topic 3 | mca, wrong, tenant, landed, quote, unable, new migration, support balance |
| Topic 4 | billing, operations, unclear, tenancy, need, tenant, service post, works, existing |
| Topic 5 | billing, experience, legacy, recon, invoice, contract, platform, resource, tagging, group |

As shown by example in Table 4, topic models 1, 2 and 3 are associated with keywords that indicate issues with subscriptions, invoicing and/or quotation aspects of a (e.g., computer implemented) product. Keywords associated with topic model 4 (e.g., billing, operations, tenant) may indicate billing experience issues with the (e.g., computer-implemented) product. Keywords associated with topic model 5 (e.g., billing, experience, recon, invoice, tagging) may indicate billing and/or invoicing issues. Broader intents of pain point comments mentioned by customers may be identified. Topic models 1, 4 and 5 may be (e.g., highly) correlated with each other. High correlation within topic models may form a cluster of topic models that represent a broader perspective or intent of a customer’s needs and pain-points. Narrowing down the number of intents or topic models (e.g., to reduce correlated topic models) may improve training and performance for unsupervised learning-based intent identification.

Clusterer 236 receives pain point topic models 270 and is configured to cluster the included pain point topic models to generate pain point topic model clusters 272. Clusterer 236 may fetch or receive multiple (e.g., 15) pain point topic models in pain point topic models 270. There may be (e.g., high) correlation among the pain point topic models (e.g., within a topic category). Clustering may assist with removing correlation between pain point topic models, which may alter (e.g., reduce the number of) pain point topic models. Reducing (e.g., narrowing) the number of pain point topic models or intent categories may reduce or avoid redundancy and improve the text analysis to understand broader perspectives of customer needs. Clusterer 236 may implement, for example, K-means clustering on probabilities of keywords associated with each topic model. K means clustering on raw text may generate less accurate results due to the high dimensionality of raw text. Raw comment text may have high dimensionality and may include high correlation within different sections of text. Dimensionality may be reduced without significant information loss. Clustering based on probabilities of topic models, modeling based on summarized text, feature extraction and/or feature reduction may improve the accuracy of a text interpretation model. Clusterer 236 (e.g., K means clustering) may be trained on the pain point topic model feature set.

Topic categorizer 238 receives pain point topic model clusters 272 and is configured to perform an analysis of pain point topic model clustering to determine a set of pain point topic categories that are included in output categories 266 generated by topic categorizer 238. Pain point topic model clustering may be evaluated, for example, using a silhouette analysis to determine best K intents or clusters. Topic categorizer 238 may (e.g., be configured to) determine a set of pain point topic categories based on the set of clusters of pain point topic models.

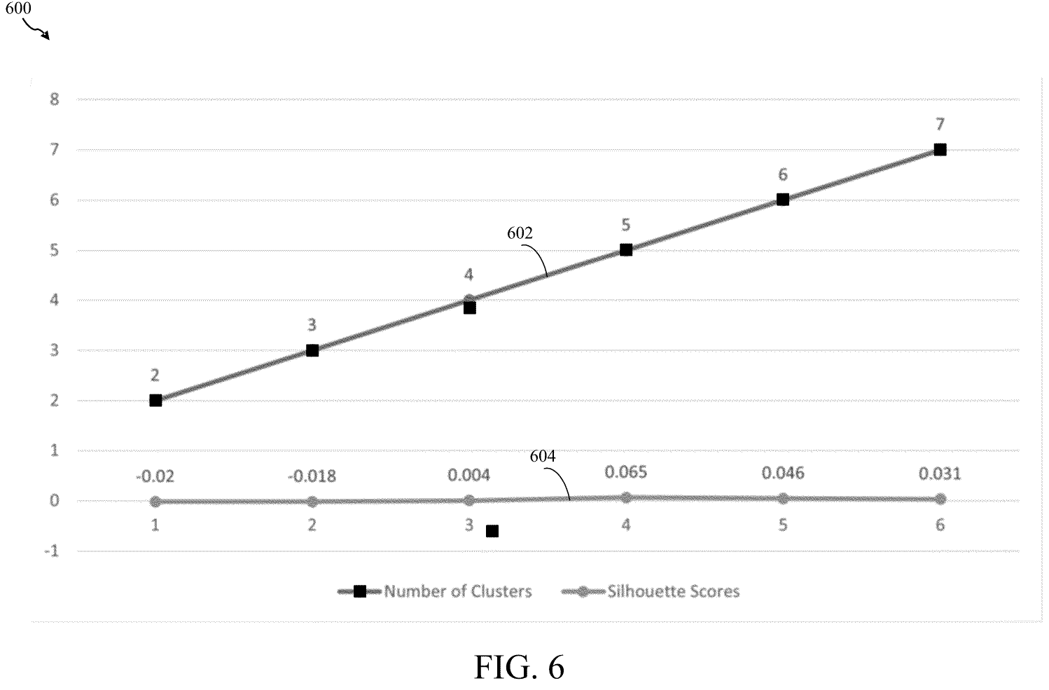

FIG. 6 shows an example of a plot 600 of an analysis of pain point topic model clustering, according to an example embodiment. Example plot 600 shows a plot line 602 of a number of clusters and a plot line 604 of corresponding silhouette scores. Plot 600 shows that clusters of pain point topic models include overlapping pain point topic models, e.g., due to high correlation of pain point topic models generated by pain point topic modeler 234. As shown in FIG. 4, if pain point topic models form two clusters, the silhouette score is -0.02. The silhouette score improves as the number of clusters increases, which signifies that clusterer 236 (e.g., K-means clustering model) is learning new features from the pain point topic models, e.g., based on vectorizer 232 (e.g., Word2Vec word embedding model), resulting in an improvement in the spread (e.g., separation) of clusters of topic models. As shown in FIG. 4, the silhouette score reaches a maximum silhouette score (e.g., 0.065) at five (5) clusters of pain point topic models. The silhouette score decreases with more than five (5) clusters.

Topic categorizer 238 may analyze the clustered pain point topic models of pain point topic model clusters 272 to determine a set of pain point topic categories included in output categories 266. Topic categorizer 238 may (e.g., based on the peak silhouette scores) determine, identify or select five (5) pain point topic categories (e.g., five (5) clusters of topic models) as an indication (e.g., the best indication) of intents expressed by customers in pain point comments within product comments 206.

Automated review and categorization of product comments by an (e.g., unsupervised learning-based) intent identification model may allow a product (e.g., software product) manufacturer to react faster and/or to utilize more (e.g., engineering) resources to generate product solutions faster for customers. Product development scheduler 124 may receive and use the determined topic categories (e.g., blocker topic categories and/or pain point topic categories) to organize (e.g., group, associate or assign) product comments based on topic categories. Product development scheduler 124 may prioritize and schedule product improvements, for example, based on the number of customers (e.g., customer deals) that depend on a similar or the same type of product improvements (e.g., as indicated in customer status 212). Priorities, e.g., with links or associations to underlying product comments, may be provided to a product engineering team in product improvement schedule(s) 122.

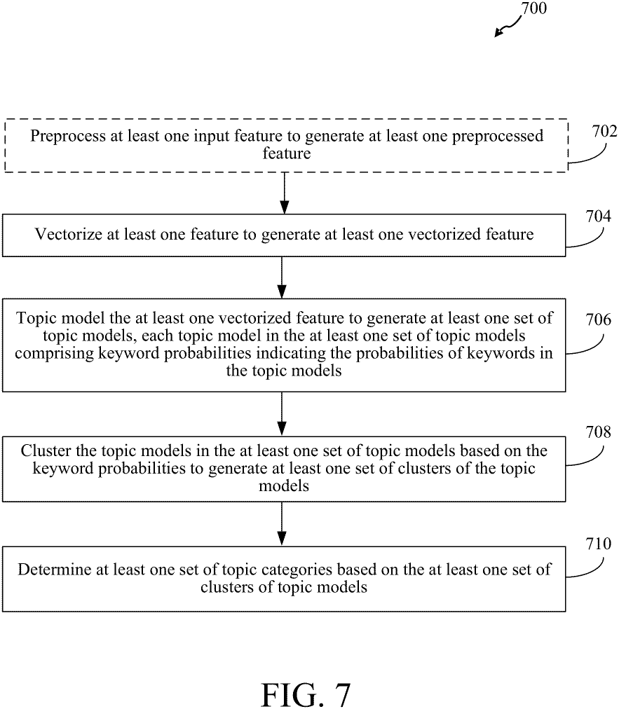

Note that text interpretation model 200 may operate in these and further ways, in embodiments. For instance, FIG. 7 shows a flowchart 700 of an example method for text interpretation based on an intent classifier model, according to an embodiment. Embodiments disclosed herein and other embodiments may operate in accordance with example method 700 such as text interpretation model 200. Method 700 comprises steps 702-710. However, other embodiments may operate according to other methods. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 7. Method 700 of FIG. 7 is simply one of many possible embodiments. Embodiments may implement fewer, more or different steps.

As shown in FIG. 7, in step 702, at least one input feature may be preprocessed to generate at least one preprocessed feature. For example, as shown in FIG. 2, feature preprocessor 218 may use NLP techniques to “normalize” the (e.g., raw) text in extracted features 210, for example, by converting the text to lowercase, removing stop words, part of speech (POS) tagging, tokenization, stemming, lemmatization, etc. A dataset of stop words of features 210 may be customized. For example, some stops words (e.g., “should”, “must” or “can”) of features 210 may be retained rather than removed if they can semantically refer to deontic expressions, such as a “prohibition” or “permission.” Retaining some stop words may help prevent contextual information loss and/or may help resolve semantic disambiguation. The preprocessed features may be output by feature preprocessor 218, to be received by blocker comments flow 228 and pain point comments flow 230. As described above, among other things, summarizer 220 of blocker comments flow 228 may selectively reduce the length of one or more of the preprocessed features by summarizing text (e.g., if the text exceeds a threshold length). As shown in FIG. 2, feature preprocessor 218 generates preprocessed features 252.

Note that step 702 is optional and may be bypassed when features 210 are extracted by feature extractor 208 into in a form suitable for further processing without the need for preprocessing (are already in a preprocessed form). In such implementations, blocker comments 216 and pain points 214 of features 210 may be provided to blocker comments flow 228 and pain point comments flow 230, respectively, as inputs.

As shown in FIG. 7, in step 704, at least one feature may be vectorized to generate at least one vectorized feature. For example, as shown in FIG. 2, blocker vectorizer 222 may vectorize preprocessed and/or summarized blocker features (received in the preprocessed features from feature preprocessor 218 and/or summarized preprocessed features received from summarizer 220) to generate vectorized text 260 and pain point vectorizer 232 may vectorize preprocessed pain point features (received in the preprocessed features from feature preprocessor 218) to generate vectorized text 268.

As shown in FIG. 7, in step 706, the at least one vectorized feature may be topic modeled to generate at least one set of topic models. A (e.g., each) topic model in the at least one set of topic models may include keyword probabilities indicating the probabilities of keywords in the topic models. For example, as shown in FIG. 2, blocker topic modeler 224 may topic model vectorized blocker features of vectorized text 260 to generate a set of blocker topic models in blocker comment topic models 262 and pain point topic modeler 224 may topic model vectorized pain point features of vectorized text 268 to generate a set of pain point topic models included in paint point topic models 270.

As shown in FIG. 7, in step 708, the topic models in the at least one set of topic models may be clustered based on the keyword probabilities to generate at least one set of clusters of the topic models. For example, as shown in FIG. 2, blocker clusterer 226 may cluster the blocker topic models of blocker comment topic models 262 to generate blocker comment topic model clusters 264 and pain point clusterer 236 may cluster the pain point topic models of pain point topic models 270 to generate pain point topic model clusters 272.

As shown in FIG. 7, in step 710, at least one set of topic categories may be determined based on the at least one set of clusters of topic models. For example, as shown in FIG. 2, topic categorizer 238 may determine a set of blocker topic categories based on the clustered blocker topic models of blocker comment topic model clusters 264 and a set of pain point topic categories based on the clustered pain point topic models of pain point topic model clusters 272 to generate output categories 266. Output categories 266 may include one or more pain point topic categories and/or one or more blocker topic categories. As described elsewhere herein, output categories 266 may be provided to one or more users as an efficiently generated set of categories for any of the uses described elsewhere herein or for any uses otherwise apparent based on the teachings herein.

### III. Example Computing Device Embodiments

As noted herein, the embodiments described, along with any modules, components and/or subcomponents thereof (e.g., product development scheduler 124, text interpretation model(s) 126, product satisfaction monitor 128, text interpretation model 200, data collector 202, feature extractor 208, feature preprocessor 218, summarizer 220, vectorizer 222, topic modeler 224, clusterer 226, blocker comments flow 228, pain point comments flow 230, vectorizer 232, topic modeler 234, clusterer 236, and/or topic categorizer 238), as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

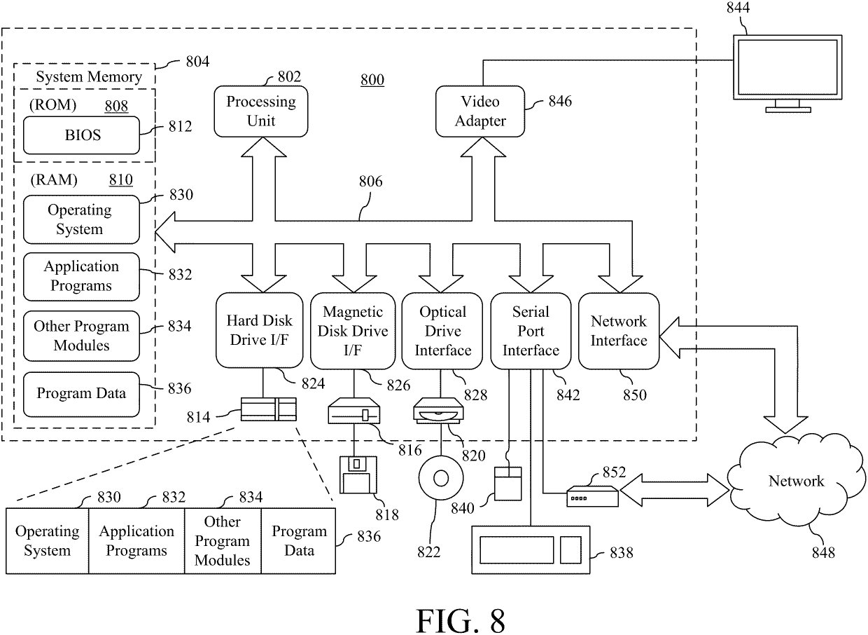

FIG. 8 shows an exemplary implementation of a computing device 800 in which example embodiments may be implemented. Consistent with all other descriptions provided herein, the description of computing device 800 is a nonlimiting example for purposes of illustration. Example embodiments may be implemented in other types of computer systems, as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random-access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 830, one or more application programs 832, other programs 834, and program data 836. Application programs 832 or other programs 834 may include, for example, computer program logic (e.g., computer program code or instructions) for implementing example embodiments described herein, including any one or more of product development scheduler 124, text interpretation model(s) 126, product satisfaction monitor 128, text interpretation model 200, data collector 202, feature extractor 208, feature preprocessor 218, summarizer 220, vectorizer 222, topic modeler 224, clusterer 226, blocker comments flow 228, pain point comments flow 230, vectorizer 232, topic modeler 234, clusterer 236, and/or topic categorizer 238.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in computing device 800. Display screen 844 may display information, as well as being a user interface for receiving user commands and/or other information (e.g., by touch, finger gestures, virtual keyboard, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” and “computer-readable storage medium” are used to refer to physical hardware media such as the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media that are separate and non-overlapping with embodiments directed to computer-readable storage media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 842, or any other interface type. Such computer programs, when executed or loaded by an application, enable computing device 800 to implement features of example embodiments described herein. Accordingly, such computer programs represent controllers of the computing device 800.

Example embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Example Embodiments

Methods, systems and computer program products are provided for machine learning text interpretation model. Text (e.g., customer comments) may be processed by an (e.g., unsupervised) text interpretation model to identify topics (e.g., product improvement categories). Text features may be processed together or separately (e.g., in parallel flows) to identify one or more sets of topic categories. Text features (e.g., customer pain point comments and customer blocker comments) may be preprocessed (e.g., normalized), summarized (e.g., selectively for length), vectorized, topic modeled, clustered (e.g., by K-means clustering) and analyzed (e.g., based on silhouette scores) to select topic categories. A topic modeler may be selected from multiple topic modelers based on perplexity scores.

In examples, a system may comprise one or more processors and one or more memory devices that store program code configured to be executed by the one or more processors. The program code may comprise a preprocessor configured to process (e.g., normalize) at least one input customer feature (e.g., provided by a customer) to generate at least one preprocessed feature (e.g., blocker features and pain-points features). The program code may comprise a vectorizer configured to vectorize the at least one preprocessed feature to generate at least one vectorized preprocessed feature. The program code may comprise a topic modeler configured to generate at least one set of topic models based on the at least one vectorized preprocessed feature. A (e.g., each) topic model in the at least one set of topic models may comprise a topic, topic keywords, and/or keyword probabilities indicating the probabilities of keywords in the topic model. The program code may comprise a clusterer configured to generate at least one set of clusters of the topic models in the at least one set of topic models based on the keyword probabilities. The program code may comprise a topic categorizer configured to determine at least one set of topic categories (e.g., classifications) based on the at least one set of clusters of topic models in the at least one set of topic models.

In examples, the program code may comprise an unsupervised learning-based text interpretation model configured to determine customer scenarios.

In examples, the topic modeler may generate N topic models. The clusterer may reduce the N topic models to K topic models, for example, using K-means clustering of the N topic models. The topic categorizer may reduce the K topic models to X topic categories, for example, using a silhouette analysis of the K topic models.

In examples, the at least one input feature may comprise a first input feature and a second input feature. The at least one preprocessed feature may comprise a first preprocessed feature based on the first input feature and a second preprocessed feature based on the second input feature. The at least one vectorized preprocessed feature may comprise a first vectorized preprocessed feature based on the first preprocessed feature and a second vectorized preprocessed feature vectorized based on the second preprocessed feature. The at least one set of topic models may comprise a first set of topic models generated based on the first vectorized preprocessed feature and a second set of topic models generated based on the second vectorized preprocessed feature. The at least one set of clusters may comprise a first set of clusters of topic models generated based on the first set of topic models and a second set of clusters of topic models generated based on the second set of topic models. The at least one set of topic categories may comprise a first set of topic categories determined based on the first set of clusters and a second set of topic categories determined based on the second set of clusters.

In examples, the first input feature may comprise customer blocker comments and the second input feature may comprise customer pain point comments. The first set of topic categories may indicate customer blocker topic categories and the second set of topic categories may identify customer pain point topic categories.

The topic modeler may be selected from a plurality of topic modelers, for example, based on a comparison of perplexity scores for the at least one set of topic models generated by each of the plurality of topic modelers.

In examples, the program code may (e.g., further) comprise a summarizer configured to summarize the at least one preprocessed feature to generate at least one summarize preprocessed feature. The vectorizer may be configured to vectorize the at least one summarized preprocessed feature.

The summarizer may be configured to selectively summarize the at least one preprocessed feature, for example, based on a length of the at least one preprocessed feature compared to a threshold length.

In examples, a computer-implemented method of improving a product for users may comprise vectorizing at least one feature to generate at least one vectorized feature. The method may comprise topic modeling the at least one vectorized feature to generate at least one set of topic models. A (e.g., each) topic model in the at least one set of topic models may comprise a topic, topic keywords, and/or keyword probabilities indicating the probabilities of keywords in the topic models. The model may comprise clusterering the topic models in the at least one set of topic models based on the keyword probabilities to generate at least one set of clusters of the topic models. The method may comprise determining at least one set of topic categories based on the at least one set of clusters of topic models.

In examples, the topic modeling may generate N topic models. The clustering may reduce the N topic models to K topic models, for example, using K-means clustering of the N topic models. The determining may reduce the K topic models to X topic categories, for example, using a silhouette analysis of the K topic models.

In examples, the at least one input feature may comprise a first input feature and a second input feature. The at least one vectorized feature may comprise a first vectorized feature based on the first input feature and a second vectorized feature vectorized based on the second input feature. The at least one set of topic models may comprise a first set of topic models generated based on the first vectorized feature and a second set of topic models generated based on the second vectorized feature. The at least one set of clusters may comprise a first set of clusters of topic models generated based on the first set of topic models and a second set of clusters of topic models generated based on the second set of topic models. The at least one set of topic categories may comprise a first set of topic categories determined based on the first set of clusters and a second set of topic categories determined based on the second set of clusters.

In examples, the first input feature may comprise customer blocker comments and the second input feature may comprise customer pain point comments. The first set of topic categories may indicate customer blocker topic categories and the second set of topic categories may indicate customer pain point topic categories.

In examples, the method may (e.g., further) comprise selecting the topic modeler from a plurality of topic modelers based on a comparison of perplexity scores for the at least one set of topic models generated by each of the plurality of topic modelers.

In examples, the method may (e.g., further) comprise summarizing the at least one feature to generate at least one summarized feature. The vectorizing may vectorize the at least one summarized feature.

In examples, the method may (e.g., further) comprise determining whether to summarize the at least one feature based on a length of the at least one feature compared to a threshold length.

In examples, a computer-readable storage medium may have program instructions recorded thereon that, when executed by a processing circuit, perform a method. The method may comprise preprocessing a first input feature to generate a first preprocessed feature. The method may comprise preprocessing a second input feature to generate a second preprocessed feature. The method may comprise vectorizing the first preprocessed feature to generate a first vectorized preprocessed feature. The method may comprise vectorizing the second preprocessed feature to generate a second vectorized preprocessed feature. The method may comprise topic modeling the first vectorized preprocessed feature to generate a first set of topic models. A (e.g., each) topic model in the first set of topic models may comprise a topic, topic keywords, and/or keyword probabilities indicating the probabilities of keywords in the topic model. The method may comprise topic modeling the second vectorized preprocessed feature to generate a second set of topic models. A (e.g., each) topic model in the second set of topic models may comprise a topic, topic keywords, and/or keyword probabilities indicating the probabilities of keywords in the topic model. The method may comprise clusterering the topic models in the first set of topic models, for example, based on the keyword probabilities associated with the first set of topic models, to generate a first set of clusters of the topic models in the first set of topic models. The method may comprise clusterering the topic models in the second set of topic models, for example, based on the keyword probabilities associated with the second set of topic models, to generate a second set of clusters of the topic models in the second set of topic models. The method may comprise determining a first set of topic categories based on the first set of clusters of topic models. The method may comprise determining a second set of topic categories based on the second set of clusters of topic models.

In examples, the first input feature may comprise customer blocker comments and the second input feature may comprise customer pain point comments. The first set of topic categories may indicate customer blocker topic categories and the second set of topic categories may indicate customer pain point topic categories.

In examples, the method may (e.g., further) comprise selecting the topic modeler from a plurality of topic modelers based on a comparison of perplexity scores for the at least one set of topic models generated by each of the plurality of topic modelers.

In examples, the method may (e.g., further) comprise summarizing the first preprocessed feature to generate a first summarized preprocessed feature. The vectorizing of the first preprocessed feature may comprise vectorizing the first summarized preprocessed feature.

In examples, the method may (e.g., further) comprise determining whether to summarize the first preprocessed feature based on a length of the first preprocessed feature compared to a threshold length.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system, comprising:
one or more processors; and
one or more memory devices that store program code configured to be executed by the one or more processors, the program code comprising:
a preprocessor configured to process at least one input customer feature to generate at least one preprocessed feature comprising blocker features and pain-points features;
a vectorizer configured to vectorize the at least one preprocessed feature to generate at least one vectorized preprocessed feature;
a topic modeler configured to generate at least one set of topic models based on the at least one vectorized preprocessed feature, each topic model in the at least one set of topic models comprising keyword probabilities indicating probabilities of keywords in the topic model;
a clusterer configured to generate at least one set of clusters of the topic models in the at least one set of topic models based on the keyword probabilities; and
a topic categorizer configured to determine at least one set of topic categories based on the at least one set of clusters of topic models in the at least one set of topic models.

2. The system of claim 1, wherein the program code comprises an unsupervised learning-based text interpretation model configured to determine customer scenarios.

3. The system of claim 1, wherein the topic modeler generates N topic models;
wherein the clusterer reduces the N topic models to K topic models using K-means clustering of the N topic models; and
wherein the topic categorizer reduces the K topic models to X topic categories using a silhouette analysis of the K topic models.

4. The system of claim 1, wherein the at least one input feature comprises a first input feature and a second input feature;
wherein the at least one preprocessed feature comprises a first preprocessed feature based on the first input feature and a second preprocessed feature based on the second input feature;
wherein the at least one vectorized preprocessed feature comprises a first vectorized preprocessed feature based on the first preprocessed feature and a second vectorized preprocessed feature vectorized based on the second preprocessed feature;
wherein the at least one set of topic models comprises a first set of topic models generated based on the first vectorized preprocessed feature and a second set of topic models generated based on the second vectorized preprocessed feature;
wherein the at least one set of clusters comprises a first set of clusters of topic models generated based on the first set of topic models and a second set of clusters of topic models generated based on the second set of topic models; and
wherein the at least one set of topic categories comprises a first set of topic categories determined based on the first set of clusters and a second set of topic categories determined based on the second set of clusters.

5. The system of claim 4, wherein the first input feature comprises customer blocker comments and the second input feature comprises customer pain point comments; and
wherein the first set of topic categories indicates customer blocker topic categories and the second set of topic categories indicates customer pain point topic categories.

6. The system of claim 1, wherein the topic modeler is selected from a plurality of topic modelers based on a comparison of perplexity scores for the at least one set of topic models generated by each of the plurality of topic modelers.

7. The system of claim 1, the program code further comprising:
a summarizer configured to summarize the at least one preprocessed feature to generate at least one summarize preprocessed feature, wherein the vectorizer is configured to vectorize the at least one summarized preprocessed feature.

8. The system of claim 7, wherein the summarizer is configured to selectively summarize the at least one preprocessed feature based on a length of the at least one preprocessed feature compared to a threshold length.

9. A computer-implemented method of text interpretation comprising:
vectorizing at least one feature to generate at least one vectorized feature;
topic modeling the at least one vectorized feature to generate at least one set of topic models, each topic model in the at least one set of topic models comprising keyword probabilities indicating the probabilities of keywords in the topic models;
clustering the topic models in the at least one set of topic models based on the keyword probabilities to generate at least one set of clusters of the topic models; and
determining at least one set of topic categories based on the at least one set of clusters of topic models.

10. The computer-implemented method of claim 9, wherein the topic modeling generates N topic models;
the clustering reduces the N topic models to K topic models using K-means clustering of the N topic models; and
the determining reduces the K topic models to X topic categories using a silhouette analysis of the K topic models.

11. The computer-implemented method of claim 9, wherein the at least one input feature comprises a first input feature and a second input feature;
the at least one vectorized feature comprises a first vectorized feature based on the first input feature and a second vectorized feature vectorized based on the second input feature;
the at least one set of topic models comprises a first set of topic models generated based on the first vectorized feature and a second set of topic models generated based on the second vectorized feature;
the at least one set of clusters comprises a first set of clusters of topic models generated based on the first set of topic models and a second set of clusters of topic models generated based on the second set of topic models; and
the at least one set of topic categories comprises a first set of topic categories determined based on the first set of clusters and a second set of topic categories determined based on the second set of clusters.

12. The computer-implemented method of claim 11, wherein the first input feature comprises customer blocker comments and the second input feature comprises customer pain point comments; and
the first set of topic categories indicates customer blocker topic categories and the second set of topic categories indicates customer pain point topic categories.

13. The computer-implemented method of claim 1, further comprising:
selecting the topic modeler from a plurality of topic modelers based on a comparison of perplexity scores for the at least one set of topic models generated by each of the plurality of topic modelers.

14. The computer-implemented method of claim 1, further comprising:
summarizing the at least one feature to generate at least one summarized feature, wherein the vectorizing vectorizes the at least one summarized feature.

15. The computer-implemented method of claim 14, further comprising:
determining whether to summarize the at least one feature based on a length of the at least one feature compared to a threshold length.

16. A computer-readable storage medium having program instructions recorded thereon that, when executed by a processing circuit, perform a method comprising:
preprocessing a first input feature to generate a first preprocessed feature;
preprocessing a second input feature to generate a second preprocessed feature;
vectorizing the first preprocessed feature to generate a first vectorized preprocessed feature;
vectorizing the second preprocessed feature to generate a second vectorized preprocessed feature;
topic modeling the first vectorized preprocessed feature to generate a first set of topic models, each topic model in the first set of topic models comprising keyword probabilities indicating the probabilities of keywords in the topic model;
topic modeling the second vectorized preprocessed feature to generate a second set of topic models, each topic model in the second set of topic models comprising keyword probabilities indicating the probabilities of keywords in the topic model;
clustering the topic models in the first set of topic models based on the keyword probabilities associated with the first set of topic models to generate a first set of clusters of the topic models in the first set of topic models;
clustering the topic models in the second set of topic models based on the keyword probabilities associated with the second set of topic models to generate a second set of clusters of the topic models in the second set of topic models;
determining a first set of topic categories based on the first set of clusters of topic models; and
determining a second set of topic categories based on the second set of clusters of topic models.

17. The computer-readable storage medium of claim 16, wherein the first input feature comprises customer blocker comments and the second input feature comprises
customer pain point comments; and
the first set of topic categories indicates customer blocker topic categories and the second set of topic categories indicates customer pain point topic categories.

18. The computer-readable storage medium of claim 16, the method further comprising:
selecting the topic modeler from a plurality of topic modelers based on a comparison of perplexity scores for topic models generated by each of the plurality of topic modelers.

19. The computer-readable storage medium of claim 16, the method further comprising:
summarizing the first preprocessed feature to generate a first summarized preprocessed feature, wherein the vectorizing of the first preprocessed feature comprises vectorizing the first summarized preprocessed feature.

20. The computer-readable storage medium of claim 19, the method further comprising,
determining whether to summarize the first preprocessed feature based on a length of the first preprocessed feature compared to a threshold length.
